(19) United States
(12) Patent Application Publication
(10) Pub. No.: US 2010/0066300 A1
(43) Pub. Date: Mar. 18, 2010

(54) Wind powered charging system for electric vehicles

(76) Inventor: John Christopher Burtch, Toronto (CA)

Correspondence Address: John Christopher Burtch, 18 Bellehaven Cres., Toronto, ON, M1M 1H3, CA

(21) Appl. No.: 12/232,338

(22) Filed: Sep. 16, 2008

(51) Int. Cl. H01M 10/46

(52) U.S. Cl. 320/101

(57) ABSTRACT

This invention uses the rushing air from the forward motion of a vehicle to turn five wind turbines and their generators. Four small turbines and generators are located just behind the front grill and utilize the air entering into the engine compartment to spin the turbines and then the generators. The fifth and larger turbine and generator are located in the rear of the vehicle where air, from four intake vents on the outside of the vehicle, is piped back and directed across the blades of the turbine. Each turbine has a gearbox to increase the rotational speed of the attached generator. The electrical current thus produced from the generators passes through regulators and is used to recharge the storage batteries of the electric vehicle as it travels forward down the road.

### FIELD OF THE INVENTION

### Technical Field

### Electrical and Mechanical Engineering

This invention will recharge storage batteries in an electric vehicle using wind turbines and generators that spin as air rushes past the turbine blades. Rushing air is taken into the vehicle and directed over five sets of turbines that in turn rotate their generators through a set of gears and provide electrical current to the storage batteries.

### BACKGROUND OF THE INVENTION

As gasoline prices steadily rise, many people are investigating the use of electric vehicles for transportation. One of the current difficulties with electric vehicles is the ability of the battery storage system to enable long distance travelling while maintaining high levels of speed. The storage batteries rapidly deplete at higher rates of speed and the distance between full charges is dramatically reduced.

In order for electric vehicles to have an extended driving range, at rates of speeds for our major highways, we need to provide additional charging systems that can supply current to the batteries on an ongoing basis as the vehicle travels. Hydrogen fuel cells, braking systems that charge the batteries and wind turbines with generators can all supply current to the battery system making this possible. A three-stage approach to powering an electric vehicle would provide a desirable solution in order to adequately extend the driving range and speed of these vehicles.

Currently hydrogen requires a large heavy fuel tank to carry the compressed fuel necessary for long road trips. Being able to use smaller, lighter tanks carrying less hydrogen would be of enormous benefit for hydrogen-powered vehicles. A wind powered generating system would easily supply the additional current to make this possible. This system would also enable plug-in electric vehicles to travel longer distances by increasing the electrical charge available at the storage batteries.

### SUMMARY OF THE INVENTION

Five wind-powered generators supply the storage batteries in an electric vehicle with a continuous charge at speeds over twenty miles per hour. The four smaller generators are powered by wind turbines located directly behind the front grill of the vehicle. A fifth and larger generator is powered by a turbine moved by rushing air piped from intake vents back to its location in the rear of the vehicle.

The four smaller front mounted wind turbines are positioned side by side and are turned by rushing air as it enters through the front grill of the vehicle. The multi-bladed turbines turn gears inside a lubricated gearbox so that the generators spin much faster than the turbines. The generators supply their current to the storage batteries through a regulator that allows the charge to flow in a constant one-way direction from the generators to the batteries.

The fifth generator is a larger model capable of producing more current than the four smaller front mounted generators. A larger turbine is used to turn the gears inside its lubricated gearbox. This in turn rotates the generator that supplies a current through a regulator and into the storage batteries. Air is directed at the multi-bladed turbine from an angled nozzle built into the housing surrounding it. Air would be discharged from a pipe at the bottom of the housing and exit the vehicle by way of an exhaust pipe.

Air intake to power the rear turbine would take place at four vents located on the outside of the vehicle and air would rush into them as the vehicle travels forward. One vent is located on the engine hood, one on the roof of the vehicle and two side vents are located behind the doors on each side of the vehicle. The interior shape of the vents forces the rushing air to the back of the vents and into flexible pipes. These pipes would combine and then direct the air from the four intake vents to the turbine located in the rear of the vehicle. Just before entering the nozzle jet, the diameter of the feed pipe is decreased in order to form a powerful stream of rushing air over the turbine blades.

### BRIEF DESCRIPTION OF THE DRAWINGS

FIG. 1 is a top plan view of the air intake vents and front grill.

FIG. 2 is a perspective view of the intake vents installed on a two-door car.

FIG. 3 is a top plan view showing the interior construction of the roof intake vent.

FIG. 4 is a top plan view showing the location of the air supply and exhaust pipes.

FIG. 5 is a top plan view showing the location of all five turbines, their generators and gearboxes as well as the location of the storage batteries.

FIG. 6 is a detailed top plan view of the four front turbines, generators and their gearboxes.

FIG. 7 is a side elevation view of the rear turbine, generator, gearbox and regulator.

### DETAILED DESCRIPTION OF THE INVENTION

Wind from the forward motion of the vehicle turns five turbines and their attached generators to provide a regulated charge to the storage batteries thus extending the range and speed of an electric vehicle. The four smaller turbines and generators are located directly behind the front grill enabling air entering the vehicle through the grill to spin them. A larger turbine and generator is located at the rear of the vehicle and rushing air is supplied there from intake vents by way of flexible pipes that combine and direct the air to the rear turbine enclosure.

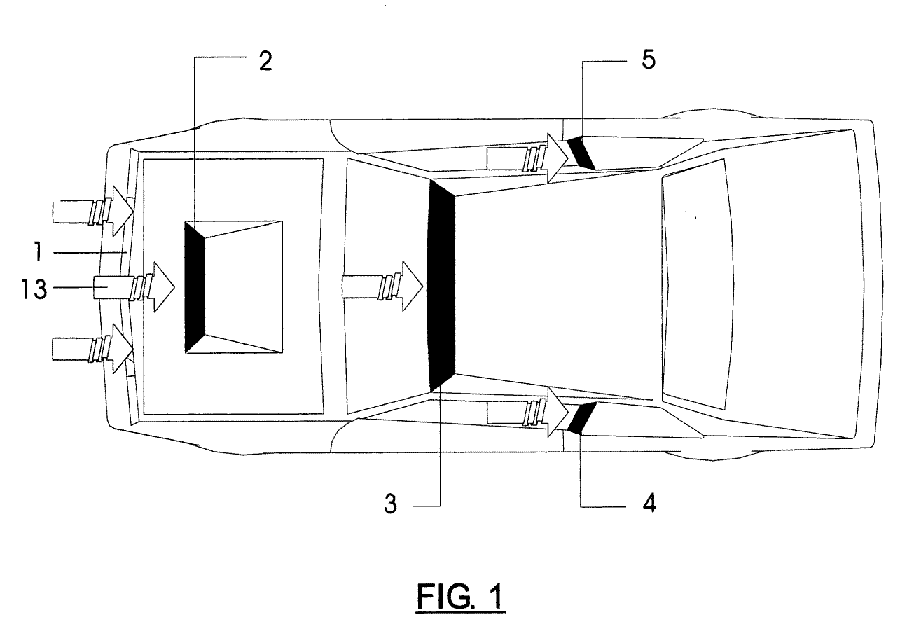

Referring to FIG. 1 there is shown a top plan view of a vehicle with four intake vents with their intake areas marked in heavy black. The large front grill of the vehicle 1 allows rushing air 13 to enter the engine compartment. The engine hood vent 2 takes in rushing air at the same time as the roof vent 3 and the side vents 4 and 5. Grills and screens cover the intake areas of each vent in order to prevent insects and debris from entering.

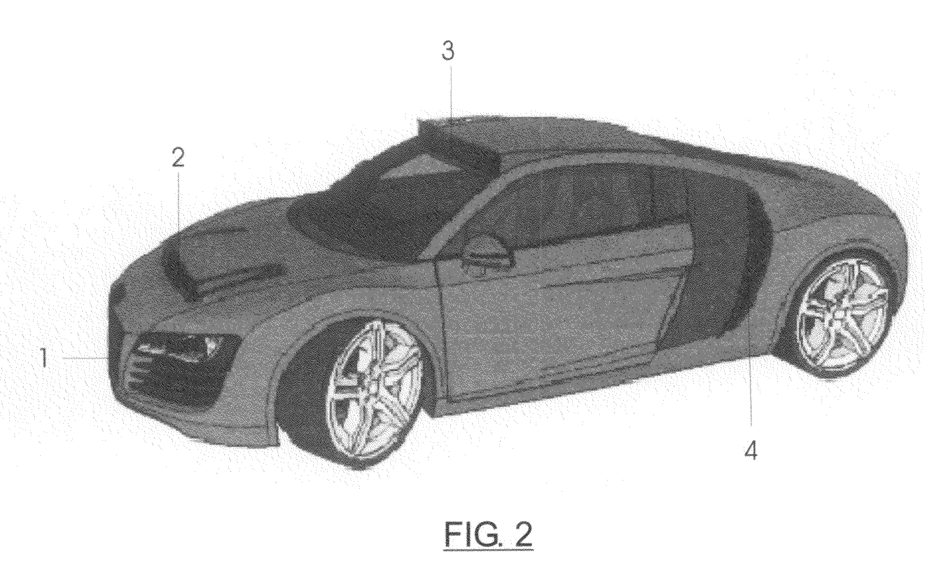

Referring to FIG. 2 there is shown a perspective view of a vehicle with four of the five air intake areas illustrated. The front grill 1 is modified so that it is as large and flat as possible in order to maximize airflow into the engine compartment. The other air intake vents are positioned on the vehicle in order to maximize intake for the rear turbine application. The engine compartment has its own intake vent 2 that would look similar to existing high performance air intake vents currently on the market. The roof intake vent 3 extends the height of the vehicle slightly but is sloped in shape so that it curves back to meet the rear window lines. This enables air travelling up the front windshield to be funnelled back into a pipe and then transported to the rear turbine. Two side vents are also located on each vehicle behind the front doors. The driver's side vent 4 is illustrated here and looks similar to high performance side vents that now exist on some fast and expensive vehicles.

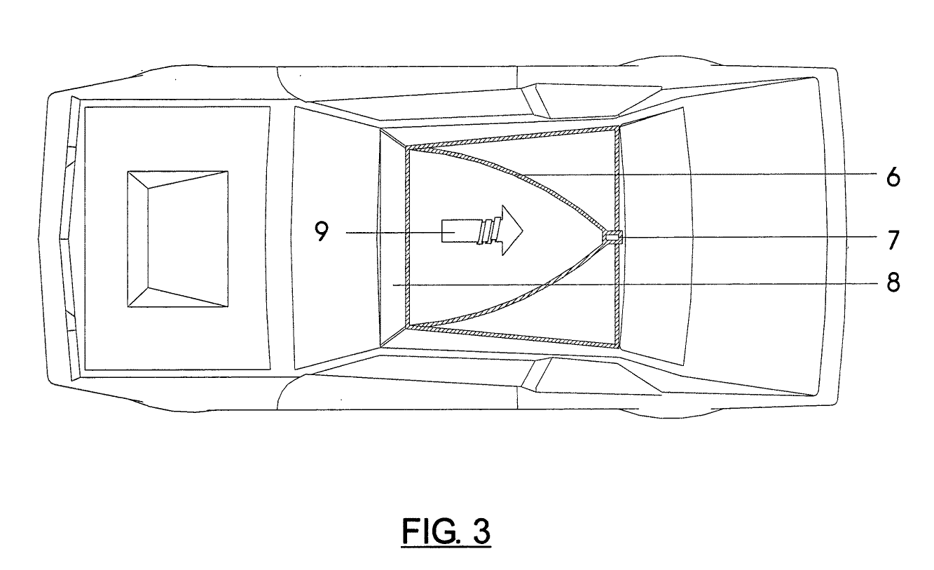

Referring to FIG. 3 there is shown a top plan view of the vehicle and the interior of the roof intake vent. The other intake vents would have a similar interior view in order to funnel and collect the air entering through the front of each vent. Air 9 entering the roof vent through its grill and screen 8 would be funnelled and directed to the rear of the vent by the curved interior side wall of the vent 6. Once it reached the rear of the vent it would enter an exhaust port 7 where a flexible pipe would direct the air to the rear turbine enclosure.

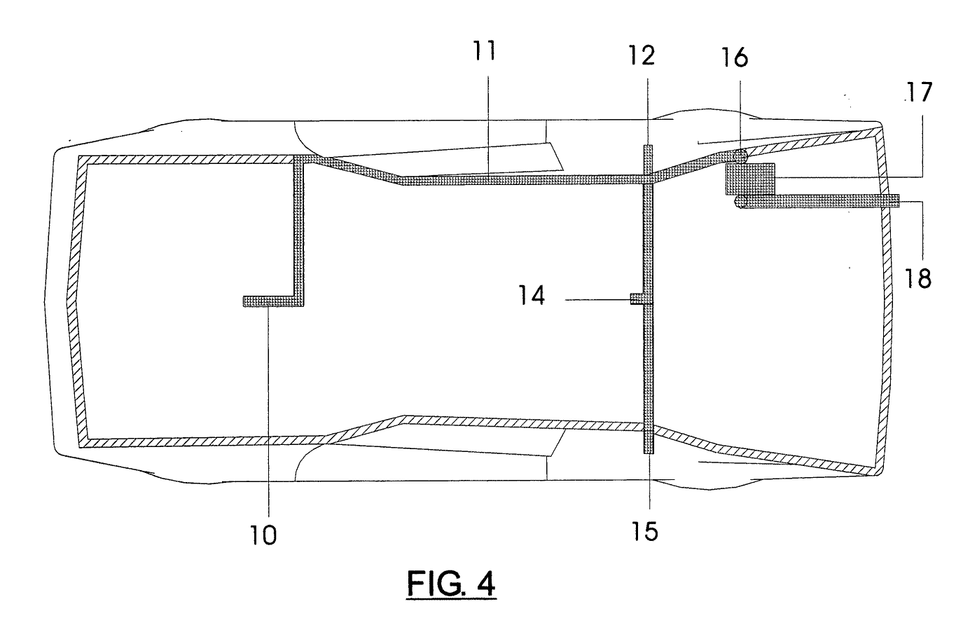

Referring to FIG. 4 there is shown a top plan view showing the location and route of the air supple pipes from the air intake vents through the turbine enclosure 17 and out of the vehicle through a rigid exhaust pipe 18. The air supply pipes would be made from a flexible pipe or tubing that would be approximately 1½ inch in diameter. At the back of each intake vent is a round exhaust port where the air is directed by the shape of each vent. The supply pipes are clamped over each port in order to secure them firmly in place. The front pipe 10 is clamped to the engine hood vent. It supplies the main pipe 11 with rushing air that then combines with air from the roof supply pipe 14 and the two side supply pipes 12 and 15. This combined air is supplied to the intake port 16 on the turbine enclosure 17. A nozzle inside the enclosure directs the rushing air over the turbine blades and the used air leaves the vehicle through the exhaust pipe 18.

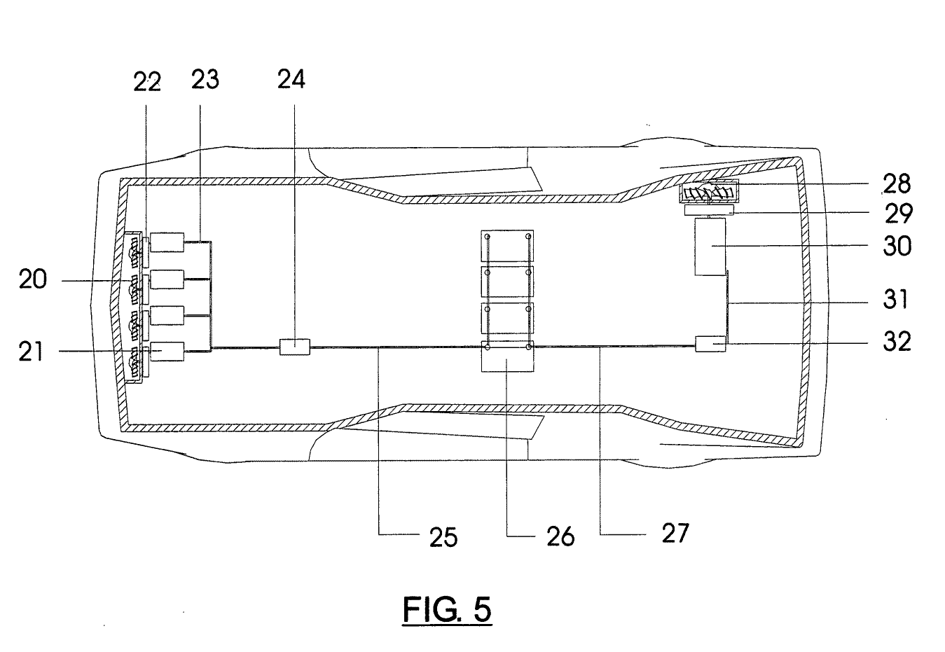

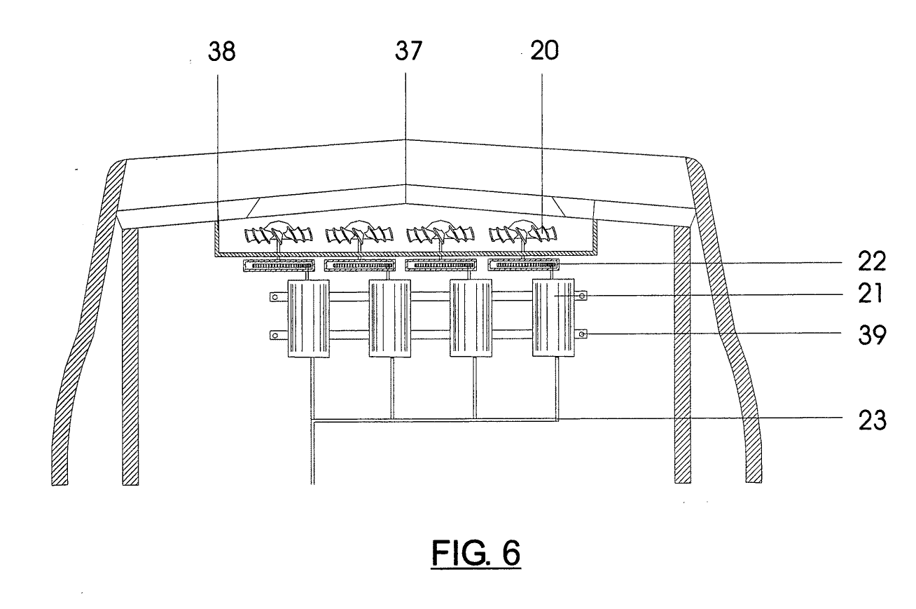

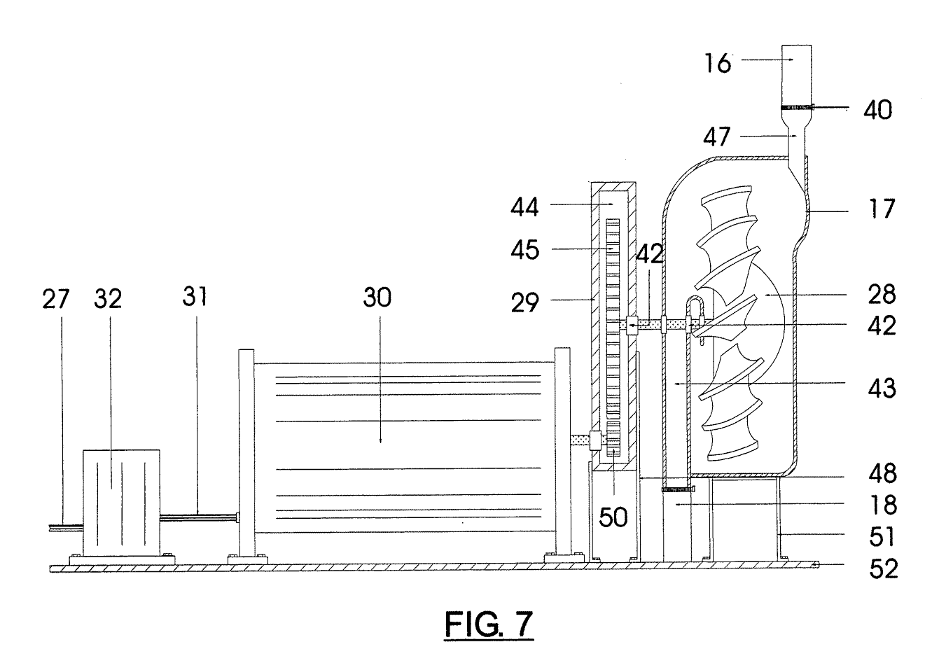

Referring to FIG. 5 there is shown a top plan view of a vehicle with all visual barriers removed so that the location of the five generators and their turbines, along with the storage batteries can easily be seen in relationship to each other. Details of the front four generators are illustrated in FIG. 6 while further details of the rear generator are shown in FIG. 7.

Shown in FIG. 5 are the front four generators 21 that are located just behind their gearboxes 22 and wind-activated turbines 20. The multi-bladed turbines are spun around by air entering through the front grill as the vehicle travels down the road. Current from these generators travels along appropriate diameter wires 23, through a regulator 24 and into the storage batteries 26.

The larger rear generator 30 is located in the back trunk area of the vehicle. Rushing air spins its turbine 28 as the vehicle travels forward down the road. The air is directed to the turbine by flexible pipes previously described. This compressed rushing air is able to turn a larger turbine than those at the front of the vehicle so that a larger generator can be used here to provide additional electrical current to the batteries.

Electrical current produced at the generator 30 travels along appropriate diameter wires 31 to a regulator 32 that supplies constant one-way current by way of another cable 27 to the storage batteries 26. The batteries can thus be slowly recharged as the vehicle proceeds down the road extending the driving range and speed of the electric vehicle.

Referring to FIG. 6 there is shown a detailed top plan view of the four front generators 21, their turbines 20 and gearboxes 22. This figure also illustrates the location of the front cowling 38 that both protects the whirling turbine blades from foreign matter and directs used air, once it has passed through the front grill and screen 37, and over the turbine blades towards the outside of the engine compartment.

Also illustrated are four gearboxes 22 that each contains two gears and a lubricant to enable smooth meshing action. The larger gear is attached to the shaft of the turbine and will turn the smaller gear on the generator shaft thus enabling the generator to spin at a much faster rate than that of the turbine. A sealed bearing around each shaft as it leaves the gearbox enables smooth rotational speeds to be maintained.

Metal brackets 39 hold the generators in place while cables 23 supply the current being produced by the generators.

Referring to FIG. 7 there is shown a detailed side elevation view of the rear generator and its associated components. The rear generator 30, gearbox 29, and wind turbine 28 are larger than the front four units. since a more powerful stream of rushing air is sent across the turbine blades here than occurs at the front turbines.

A flexible pipe 16, from the four intake vents directs rushing air into a smaller diameter angled nozzle 47. A gear clamp 40 keeps the pipe in place while a second clamp keeps the exhaust pipe 18 in place. The exhaust pipe 18 would continue through the floor of the trunk, turn 90 degrees and extend slightly beyond the rear bumper of the vehicle. The turbine enclosure 17 protects the angled blades of the turbine 28 and helps to direct the rushing air across the turbine and out a channel 43 towards the exhaust pipe 18. Sealed bearings 42 inside the turbine enclosure 17 facilitate the smooth rotation of the turbine shaft, while angled support brackets 48 and 51 securely hold the turbine enclosure 17 and gearbox 29 in place.

The gearbox in FIG. 7 is constructed exactly the same as the four gear boxes in FIG. 6 except it is larger in order to accommodate the larger gears 45 and 50, attached to a larger turbine 28 and generator 30. Two sealed bearings 42 also allow for smooth rotation of both the turbine and generator shafts through the wall of the gearbox 29. The gearbox also utilizes two different sized gears, a large gear 45 attached to the end of the turbine shaft and a small gear 50 attached to the end of the generator shaft enabling the generator to rotate at a much faster rate than the rotations of the wind turbine. A lubricant 44 inside the gearbox also enables the smooth meshing of the gears with minimal friction.

Because of the larger turbine a larger generator can be used in this rear location compared to the front application. The increased current produced at this generator 30 travels through an appropriate diameter cable 31 to a regulator 32 where a constant one-way flow of electricity is sent to the storage batteries by way of another cable 27 connecting the two.

1. A system for charging the batteries in an electric vehicle making use of wind turbines and generators that spin as a result of the forward motion of the vehicle. Four wind turbines along with their gearboxes and generators are located just behind the front grill of the vehicle. The four turbines are positioned so that they spin as a result of air being forced over the angled blades as the vehicle travels forward. Each of the four turbine shafts spins a large gear inside a gearbox that in turn rotates a small gear attached to each generator's shaft. A lubricant is used inside the four gearboxes in order to minimize the friction between the gears. This gear ratio enables the four generators to rotate at much faster speeds than their turbines. Electricity produced from the generators is sent to a regulator in order to supply a steady, one-way flow of current to the storage batteries. A fifth and larger turbine, gearbox and generator are located in the rear trunk area of the vehicle. Rushing air that is taken into the vehicle from four intake vents as the vehicle travels forward rotates this turbine. The intake vents are located on the engine hood, the roof of the vehicle, and one on each side of the vehicle behind the doors. Flexible pipes direct the moving air back from the vents to an angled nozzle in the turbine's enclosure. The nozzle aims a focused stream of air over the turbine blades, thus spinning the turbine blades more rapidly as the speed of the vehicle increases. This system enables a larger turbine to be used than those located at the front of the vehicle. The turbine shaft is also attached to a large gear inside the gearbox that in turn rotates a smaller gear attached to the generator's shaft with a lubricant used to minimize friction. The electricity from this generator is sent to its own regulator so that it can also provide a constant, one way supply of current to the storage batteries. As the forward speed of the vehicle increases so would the current supplied to the storage batteries thus enabling longer and faster trips than would be possible by an electric vehicle running solely from the current contained in its storage batteries at the outset of its journey.

2. A system according to claim 1, characterized by using four generators, four gearboxes, four wind turbines and a regulator to produce an electrical current in order to send a trickle charge to the storage batteries of an electric vehicle. The turbines are positioned so that the forward motion of the vehicle spins them as air enters through the front grill. This kinetic energy is then transferred through the gearboxes to the generators. The electrical energy produced in the generators then travels through a regulator and slowly recharges the storage batteries. Four turbines, gearboxes and generators are used in order to maximize the air passing through the modified front grill of an electric vehicle.

3. A system according to claim 1, characterized by using a generator, gearbox and turbine that is activated by rushing air taken in through four vents located on the outside of the vehicle. Air travels from the four intake vents by means of connected flexible pipes that direct the air to an enclosure around the turbine at the rear of the vehicle. The enclosure, around the turbine blades, contains an angled nozzle that directs the incoming air across the blades of the turbine thus causing it to spin rapidly as the air rushes past. The shaft of the turbine spins inside several sealed bearings and the end of the shaft is located inside a gearbox. A large gear is attached to the end of the turbine shaft that turns a small gear on the end of the generator's shaft. A lubricating liquid is used inside of the gearbox in order to minimize friction. The generator thus rotates at a greater number of rotations per minute than does the turbine due to the gear ratio employed. Electricity produced from this generator is fed into a regulator that provides constant, one way current to recharge the storage batteries as the vehicle travels down the road.

4. A system according to claim 3, characterized by using four intake vents and flexible pipes to supply moving air to the turbine located in the rear of the vehicle. The intake vents are located on the engine hood, the roof and both sides of the vehicle behind the front doors. These vents have grills and screens and funnel the entering air back to a flexible pipe attached to the rear of the vent. The flexible pipes are routed and joined together so that all of the air entering the four vents is directed into one pipe that feeds into the enclosure surrounding the turbine. This enclosure surrounds and protects the turbine blades while a built in nozzle directs the airflow across the blades of the turbine. The enclosure also contains an exhaust port, at its lower end, in order for the utilized air to exit by way of a flexible pipe and a rigid exhaust pipe at the rear of the vehicle.

5. A system according to claim 4, characterized by using an enclosure surrounding the turbine blades. This enclosure has an intake port on its top end where air, from the intake vents on the vehicle, is supplied to the enclosure by flexible pipes. The supply pipe is clamped onto the intake port and the rushing air is directed through a smaller angled nozzle built into the turbine enclosure. This nozzle directs the rushing air across the angled blades of the turbine causing it to spin rapidly. Three enclosed bearings also support the shaft of the turbine and enable it to rotate freely within the enclosure. An exhaust channel is located behind the turbine blades so that the fully utilized air is directed down towards the exhaust port. A flexible pipe is clamped over the exhaust port that then directs the air into a rigid exhaust pipe in order to leave the rear of the vehicle. The turbine enclosure is designed to not only protect the turbine blades as they spin but also to direct airflow across the blades and out of the enclosure. The concentrated blast of air from the angled nozzle across the turbine blades enables it to power a larger generator than those used at the front of the vehicle.
